(19) United States
(12) Patent Application Publication
(10) Pub. No.: US 2025/0008977 A1
(43) Pub. Date: Jan. 9, 2025

(54) METHOD FOR MANUFACTURING A COMPOSTABLE BEVERAGE CAPSULE

(71) Applicant: Delica AG, Buchs (CH)

(72) Inventors: Caroline SIEFARTH, Basel (CH); Roland AFFOLTER, Möriken (CH); Tim THILLA, Weil am Rhein (DE); Silvia GROSS, Padua (IT); Chiara TURIONI, Padua (IT)

(73) Assignee: Delica AG, Buchs (CH)

(21) Appl. No.: 18/711,227

(22) PCT Filed: Nov. 15, 2022
(86) PCT No.: PCT/EP2022/081956

§ 371 Date: May 17, 2024

(30) Foreign Application Priority Data
Nov. 19, 2021 (EP) 21209384.3

(51) Int. Cl. A23F 5/28; A23F 3/22; A23F 3/32; A23F 5/12; A23F 5/40; A23F 5/42; B65D 65/46; B65D 85/804

(52) U.S. Cl. CPC A23F 5/28; A23F 3/22; A23F 3/32; A23F 5/12; A23F 5/40; A23F 5/42; B65D 65/466; B65D 85/8046

(57) ABSTRACT

A method for manufacturing a capsule with a coating, for preparing a beverage by introducing water. The method comprises the steps of:
(i) providing a compact of a beverage powder or a mixture of beverage powders, the compact having a surface that is coated or uncoated;
(ii) contacting at least a portion of the surface, preferably the entire surface, of the compact with at least one polysaccharide, at least one crosslinking agent, and at least one polyol to form a layer;
(iii) drying of the layer.

The layer formed in ii) and iii) is adjusted with a degree of swelling between 20% and 900%, preferably 60% to 850% and most preferably between 100% and 800%; and/or the capsule is expanded on contact with water by 0.3% to 6%, preferably 0.5% to 5.5% and most preferably 1.0% to 4.0%.

The present invention relates to a method for manufacturing a compostable beverage capsule, in particular for preparing a beverage from a beverage powder by introducing water, to such a capsule and to the use of such a capsule, having the features of the generic concept of the independent claims.

The provision of a luxury food such as coffee in capsule form is well known. However, the materials usually used as wrapping materials, such as plastics or aluminum (e.g. EP 0 468 079 A1), have the disadvantage that they can only be recycled with great effort and are usually not compostable.

Biodegradable coffee capsules are known. DE 10 2018 201 187 B3 describes a capsule made of a wood material compounded with bioplastic. However, the problem with such capsules made of compostable materials lies in their processing. Although these capsules can be manufactured using injection molding technology, depending on the material used, dimensional accuracy is difficult to ensure due to the high fiber content. In particular, sealing contours, which enable the preparation of a beverage under high pressure, are difficult to form with low tolerances.

DE 10 2014 000 187 B4 describes another biodegradable capsule made from a pressed coffee powder coated with a biodegradable layer. For this purpose, the coffee compact is preferably coated with liquid cellulose from polysaccharides, a polyolemic spacer and a crosslinker. However, DE 10 2014 000 187 B4 makes no statement on the extent to which the problem of sealing contours can be solved in a beverage preparation under high pressure.

WO 2017/167624 A1 describes a biodegradable capsule for preparing a beverage from a polysaccharide. The capsule is coated with a coating layer of a cross-linked polysaccharide.

It is therefore the object of the invention to overcome the disadvantages of the prior art. In particular, it is intended to provide a method of manufacturing a capsule for preparing a beverage which provides a capsule with an improved seal also with compostable materials. It is also an object of the invention to provide capsules made of compostable materials of various sizes and geometries.

This task is solved by the methods and devices defined in the independent patent claims. Further embodiments result from the dependent claims.

A first aspect of the invention relates to a method of manufacturing a capsule having a coating, for preparing a beverage from a beverage powder by introducing water. The method comprises the steps of:
(i) Providing a compact of a beverage powder or a mixture of beverage powders, the compact having a surface that is coated or uncoated;
(ii) contacting at least a portion of the surface, preferably the entire surface, of the compact with at least one polysaccharide, at least one crosslinking agent, and at least one polyol to form a layer;
(iii) Drying of the layer.

The layer formed in steps ii) and iii) is adjusted with a degree of swelling of between 20% and 900%, preferably 60 to 850% and most preferably between 100% and 800%; and/or the capsule is expanded on contact with water by 0.3 to 6%, preferably 0.5 to 5.5% and most preferably 1.0 to 4.0%; and/or the capsule exhibits, in particular after being rinsed with water, in a breaking strength test a maximum percentage expansion in a direction transverse to a pressing direction of at least 15%, in particular at least 20%, preferably at least 25%, particularly preferably at least 30%.

According to the present invention, a “compact” is understood to be a core material which has been compressed under pressure. Providing the core material of the capsule as a compact is advantageous if, according to the invention, the core material is at least partially coated with the coating according to the invention by dipping, coating or spraying, so that it does not disintegrate during the coating process. The core material therefore preferably has a certain strength. This can preferably be achieved by carrying out the compression of the core material with a compression pressure in the range of 1-100 MPa, preferably 5-50 MPa, so that the resulting compact has a strength in the range of 3-120 N, preferably 5-60 N.

The compression pressure to be applied to produce the compact depends on the properties of the core material, in the case of coffee powder, for example, on the grind, degree of roasting and moisture content of the powder. In the case of coffee powder in particular, it can be observed that powder with a smaller fat or oil content, e.g. decaffeinated coffee powder, requires a higher compression pressure in order to achieve a stable compact.

The strength of the compact is determined by positioning the compact between two plates of a compression tensile testing machine (for example equipped with an Xforce P load cell from Zwick/Roell) and determining the force required to crush the compact. This method is also described in WO 2008/123775 A1, p. 3.

The degree of swelling is calculated from the difference between the wet weight of the coating and the dry weight of the coating according to the equation

$$SW = [ ( wet weight - dry weight ) / dry weight ] \cdot 100 \% .$$

The degree of swelling is determined as follows:

A film is prepared from at least one polysaccharide, at least one polyol, and at least one crosslinking agent. This film is dried at 35° C. and 50% rH for 120 to 140 h until constant weight, punched out circularly (d=2.5 cm) and the dry weight is then determined. The dried film is then immersed in deionized water for 6 h, patted dry and the wet weight determined.

The expansion of the capsule on contact with water is determined as follows:

The capsule diameter in the dry state is determined using a caliper gauge. The exact measuring point is marked. The capsule is then immersed in 90° C. hot water. After 60 seconds, the capsule is removed and patted dry. The diameter is then determined again at the marking and the percentage expansion is determined.

The maximum percentage expansion of the capsule in a breaking strength test is determined as follows:

For the breaking strength test the capsule is positioned between two parallel plates of a compression tensile testing machine (for example equipped with an Xforce P load cell from Zwick/Roell). The capsule is aligned centrally on the lower plate in the direction of extraction, or in the direction of compression in the case of a rotationally symmetrical compact, for example with a spherical or cube shape. The plates have a diameter at least 50% larger than the maximum capsule diameter.

The parallel plates are slowly moved together and a force-path diagram is recorded. Simultaneously with this crack or break, a drop in force is observed. When the measured force is below the force drop threshold of 40%, the breaking strength test is terminated. The maximum measured force without damage to the shell is output as the breaking strength. In the case of a multi-layered shell, damage or a tear through the shell down to the core material is understood as damage to the shell. At the same time, the expansion of the capsule is recorded in a direction transverse to the pressing direction, i.e. in the direction parallel to the plates. The recording of the expansion in the transverse direction is recorded visually. Any flange of the capsule shell is not taken into account when recording the expansion. The expansion is recorded in two mutually perpendicular directions. An average value is formed from the two measured values. The maximum expansion transverse to the pressing direction is determined at the maximum force without damage, i.e. at the breaking strength. If the capsule is not damaged at a force of 600 N, the maximum expansion is determined at a force of 600 N.

Depending on the design of the shell, its deformability can be influenced by wetting or rinsing with water. For example, before carrying out the breaking strength test, the capsule can be immersed in a water bath at a temperature of 75° C. for 5 s and kept under water. The water is depressurized during this process. The capsule is in a wet state after such wetting or rinsing.

Such deformability ensures that the capsule can conform to the shape of the brewing chamber when the brewing chamber is closed or when a brewing liquid, typically hot water, is introduced. It can be ensured that the capsule fits tightly against the walls of the brewing chamber and that the entire amount of brewing liquid can be passed through the capsule. Poor quality of the prepared beverage due to leakage along the outside of the capsule can be prevented.

The beverage powder is preferably coffee powder, tea powder or milk powder. The beverage powder mixture may be a coffee blend, coffee substitute blend, tea blend, drinking chocolate, cocoa blends, latte blend, milk powder, fruit milk powder, vegan milk substitute powder, instant coffee, coffee substitute products, and dry soup, and combinations thereof.

The contacting in step ii) is preferably done by spraying on a polysaccharide, crosslinking agent and polyol solution, either the separate solutions are sprayed on one after the other or the at least one polysaccharide, the at least one crosslinking agent and the at least one polyol are mixed and sprayed on as a solution mixture. However, it is also possible that contact with the surface of the compact is made by immersing the compact in separate solutions of the polysaccharide, the crosslinking agent and the polyol, or by immersing the compact in a mixture of these compounds. Coating with the at least one polysaccharide, at least one crosslinking agent and at least one polyol or a mixture of these compounds is also possible.

Drying in step iii) can be carried out at room temperature or elevated temperature but drying at 35° C. and 50% rH for 120-140 h and subsequent heat treatment, hereinafter also referred to as ripening, is particularly preferred.

Alternatively, drying in step iii) could also be carried out using desiccants, for example silica gel. However, other hygroscopic desiccants are also conceivable.

Particularly preferably, the degree of swelling of the applied layer is adjusted by heat treatment or curing at 7% rH at a temperature below 100° C., preferably in the range from 25 to 100° C., more preferably 35 to 80° C. and very particularly preferably 50 to 70° C. The ripening can be carried out for between 0.5 and 24 hours, preferably 1 and 16 hours, and particularly preferably between 3 and 9 hours.

Heat treatment at lower temperatures is economically advantageous and reduces the energy consumption of such a manufacturing process.

Surprisingly, it was found that the degree of swelling of the deposited layer is adjustable and decreases with increasing ripening time.

The adjustable degree of swelling allows the capsules to be designed so that they can be easily inserted into common beverage preparation machines and the coating swells on contact with water, thus creating sealing contours within the machine. This prevents the water from passing through the machine to the side of the capsule without wetting the beverage powder, thus negatively affecting the quality of the beverage. In particular, these sealing contours withstand the pressure required to prepare the beverage.

Also, expansion of the coated capsule allows for deformability, which allows for sealing within a brewing chamber that deviates from the capsule shape and prevents the quality of the beverage from being negatively affected.

The crosslinking of the polysaccharide can be ionic and/or coordinative or covalent. The crosslinking ensures the production of a coating which, on the one hand, stabilizes the compact to make it transportable and, on the other hand, after contact with water, makes it elastic enough to be perforated and to allow water to flow through it, as well as allowing deformation of the coated compact. The manufacturing process offers the possibility to adjust stability and elasticity in such a way that crack damage during extraction can be avoided. In addition, an aroma-tight coating is produced which preserves aroma substances of the compact, for example coffee, and thus enables the production of a beverage with good sensory quality even during longer storage.

The coating is preferably insoluble in water, so that the compact does not disintegrate even after prolonged contact with hot water.

Preferably, the polyol after step iii) is crosslinked with the at least one polysaccharide and/or intercalated into the coating.

In this context, intercalation is understood as non-covalent integration into the network. For example, intercalation can occur due to electrostatic interactions.

The polyol allows the mechanical properties of the coating to be adjusted in terms of elasticity.

Steps (ii) and (iii) may be repeated several times, preferably 2 to 50 times, more preferably 2 to 20 times, most preferably 2 to 10 times, and even most preferably 2 to 5 times.

By repeating the steps, a coating can be produced from several layers. This in turn makes it possible to adjust the thickness of the coating as required.

At least a portion of the surface of the compact may additionally be contacted with at least one polysaccharide and at least one non-polyol crosslinking agent. Preferably, this is also followed by a drying step.

Thus, a coating can be created from layers with polyol and without polyol, allowing the properties of the coating to be further adjusted to the appropriate needs.

Preferably, the coating is made of two to fifty layers, more preferably two to twenty layers, most preferably two to ten layers and even most preferably two to five layers.

The coating may have at least one layer with polyol and at least one layer without polyol.

The layer thickness of the coating can be optimally adjusted via the number of layers, and stability and elasticity or flexibility can be adapted to the intended use.

For example, the compact may first be coated with one or more layers of at least one polysaccharide and at least one crosslinking agent without polyol, and then coated with one or more layers of at least one polysaccharide, at least one crosslinking agent, and at least one polyol, or vice versa.

A coating consisting initially of two layers with polyol and an outer layer without polyol has proved to be particularly advantageous. A coating consisting of one layer with polyol and an outer layer without polyol is particularly preferred.

For example, the compact according to step iii) may additionally be contacted with at least one further polysaccharide and at least one cellulose or cellulose derivative.

Preferably, the individual layers of the coating have thicknesses between 30 and 600 μm, preferably between 50 and 300 μm, and most preferably between 50 and 200 μm.

Preferably, the at least one polysaccharide of the coating is selected from the group comprising alginates, starch, starch derivatives, carrageenans, cellulose, cellulose derivatives, chitin, chitosan, pectins, guar, xanthan gum, locust bean gum, gum arabic, pullulan, and agar; and combinations thereof. Preferred polysaccharides are those that have good food compatibility.

On the one hand, such polysaccharides are readily accessible, usually of natural origin and thus sustainable, and also readily biodegradable.

In particular, an alginate, for example alkali metal alginate, especially sodium alginate, is preferred.

Sodium alginate is a food additive and is approved under the European approval number E 401 for food additives. It is therefore particularly suitable for the production of a beverage capsule in terms of food compatibility.

The at least one crosslinking agent may be selected from compounds having one or more carbonyl and/or carboxyl functions, in particular dialdehydes, diketone compounds and di-, tri- or tetracarboxylic acids; and combinations thereof. The diketone compounds may be 1,2-diketones, preferably 2,3-butanedione, 2,3-pentanedione and 2,3-hexanedione. However, the use of acetone is less suitable.

The diketone compounds preferably have the formula CₓH_{y}O₂ with x=4-6 and y=6 to 10. The di- and tricarboxylic acids preferably have the general formula CₓH_{y}O_{z} and preferably have a chain length of at least four carbon atoms and a maximum of 6 carbon atoms. Thus, compounds in which x=4-6, y=4-10 and z=4-7 are particularly preferred.

The at least one crosslinking agent is particularly selected from the group consisting of citric acid, fumaric acid, maleic acid, malic acid, tartaric acid and adipic acid; and combinations thereof. These crosslinking agents are registered as food additives (E-numbers) and are therefore particularly suitable for use in food technology and are harmless to health.

The at least one crosslinking agent can also be a salt of a divalent or higher-valent cation, in particular an alkaline earth metal cation, and very preferably CaCl₂. In this case, crosslinking preferably takes place via ionic and/or coordinative bonds. Such polysaccharides crosslinked via ionic and/or coordinative bonds are particularly easy to prepare and do not impair the biodegradability of the polysaccharide used. The ionic and/or coordinative crosslinking can be achieved, for example, by means of polysaccharides which have anionic groups, such as carboxylate groups or sulfonate groups.

It is also possible to choose different crosslinking agents, for example covalent and/or coordinate/ionic bonding crosslinking agents.

Advantageously, the at least one polyol is selected from the group consisting of aliphatic polyols, preferably ethylene glycol, propanediol, butylene glycol, triethylene glycol, polyethylene glycol, polypropylene glycol, sorbitol, erythritol, xylitol, and most preferably glycerol; cyclic polyols, preferably glucose, fructose, mannose, galactose, oligofructose, inulin, isomaltulose, trehalose; sugar substitutes, preferably mannitol, isomalt, maltitol, lactitol; and aromatic polyols, preferably cyanidin, corilagin, digallic acid, tannic acid and gallic acid; and combinations thereof.

Preferably, the chain length of the polyol is between 2 and 20 carbon atoms, preferably 2 and 10 C-atoms and particularly preferably 3 and 6 C-atoms. The carbon chains may be linear or branched and separated by heteroatoms, in particular oxygen. Preferably, the polyol has between 2 and 10, preferably 3 and 6, free hydroxyl (OH)-groups.

The at least one polysaccharide may comprise an alginate, the at least one polyol may comprise glycerol, and the at least one crosslinking agent may comprise citric acid. This combination gives a particularly easy-to-use coating that additionally meets food compatibility and biodegradability requirements.

Other particularly preferred combinations that meet food compatibility requirements are mentioned below.

The at least one polysaccharide may comprise an alginate, the at least one polyol may comprise glycerol, and the at least one crosslinking agent may comprise tartaric acid.

The at least one polysaccharide may comprise an alginate, the at least one polyol may comprise sorbitol, and the at least one crosslinking agent may comprise citric acid.

The at least one polysaccharide may comprise an alginate, the at least one polyol may comprise sorbitol, and the at least one crosslinking agent may comprise calcium chloride.

The at least one polysaccharide is preferably provided in an aqueous solution having a concentration of 1.0 to 5.0% (w/v) preferably 1.0 to 3.0% (w/v) and more preferably 1.0 to 1.7% (w/v).

In the case of a covalently crosslinked crosslinking agent, the at least one crosslinking agent may be provided in an aqueous solution having a concentration of from 5 to 30% (w/v), preferably from 10 to 25% (w/v), and most preferably from 15 to 20% (w/v).

In the case of an ionic and/or coordinate crosslinking agent, the crosslinking agent can be provided in an aqueous solution with a concentration of 2 to 10 (w/v), preferably 3 to 7% (w/v), and particularly preferably 5% (w/v).

The at least one polyol is preferably provided in an aqueous solution having a concentration of 0.5 to 15% (w/v), preferably 0.75 to 12.5% (w/v) and more preferably 0.75 to 10% (w/v).

These concentration ranges have the advantage that the solutions can be applied well to the compact. Particularly during spraying, the solutions should not be too concentrated to prevent clogging of the nozzle. At the same time, however, the solutions must be concentrated enough to allow crosslinking and/or incorporation of the individual components of the coating.

It is particularly preferred that the at least one polysaccharide and the at least one crosslinking agent are mixed prior to contacting the surface of the pressed article in step (ii). In this way, the process can be made particularly economical.

It is further preferred to mix the at least one polysaccharide, the at least one polyol, and the at least one crosslinking agent prior to contacting the surface of the compact in step (ii), thereby providing an economical method of operation.

It is also possible to contact the surface of the compact in step ii) with the at least one polysaccharide, the at least one polyol and the at least one crosslinking agent in subsequent steps.

Subsequent steps have the advantage that the individual components can be replaced without effort.

Alternatively, it is possible to mix the at least one polysaccharide and the at least one polyol prior to contacting the surface of the compact in step ii) and to immerse the compact in a solution comprising the at least one crosslinking agent after contacting the mixture.

Preferably, in step ii), the at least one polysaccharide and the at least one polyol are present in equal weight ratios and the at least one crosslinking agent is present in ten times the weight ratio in a preferably aqueous solution, in particular 1.5% (w/v): 1.5% (w/v): 15% (w/v).

Particularly preferred is the provision in a common solution. However, it is also possible to provide separate solutions as described above.

Alternatively, in step ii), the at least one polysaccharide, the at least one polyol, and the at least one crosslinking agent are present in a weight ratio of 1.5% (w/v):10% (w/v):5% (w/v).

In addition, fibers can be introduced into the coating, for example cellulose fibers. The fibers may be present in one or more layers. Preferably, the cellulose fibers are introduced in step (ii), for example by addition to one or more of the solutions. It is also possible to provide the cellulose fibers in a separate suspension and to contact the compact with this suspension.

For example, VITACEL® Powdered Cellulose LC 200 can be used as cellulose fibers. VITACEL® is purified, mechanically ground cellulose produced by processing alpha-cellulose obtained directly from natural plants. In this process, the compact can be dipped, for example, into an alginate-polyol-cellulose mixture and then into a calcium chloride bath for gelation. The cellulose fiber LC 200 is used in a concentration between 0.2-2% (w/v), preferably 0.5-1.5% (w/v), particularly preferably 0.5-1% (w/v).

It is also possible to use microcrystalline cellulose (MCG). VIVAPUR MCG 611 FS, for example, is suitable for this purpose. The compact can be dipped into an alginate-polyol-MCG mixture, for example, and then into a calcium chloride bath for gelation. The microcrystalline fiber MCG is used in a concentration between 0.1-5%, preferably 0.5-2.0%, particularly preferably 0.75-1.5%.

However, it is also possible to use ethyl cellulose. ETHOCEL™ Standard 100 Premium, for example, is suitable for this purpose. For this purpose, for example, ethanol can be heated to around 75° C. and ethyl cellulose dissolved in it. The compact can then be dipped in an ethylcellulose-ethanol mixture and unrolled onto a paper so that a first layer is arranged on the compact, followed by at least one further alginate-surrounding layer, producible as previously described. The ethyl cellulose is used in a concentration between 1-30% (w/v), preferably 2-20% (w/v), more preferably 3-10% (w/v).

The cellulose fiber gives the individual layers additional stability.

Ethyl cellulose acts particularly preferentially as an impregnating layer to prevent moisture absorption into the compact during coating.

It was surprisingly found that ethyl cellulose prevents the transport of moisture across the layer(s) to the pressed product regardless of the composition of the layers. Ethyl cellulose is thus suitable as a moisture barrier-forming layer for any type of beverage capsules containing powdered beverages, in particular for capsules whose coating is derived from an aqueous solution.

A second aspect of the invention relates to a capsule for preparing a beverage from a beverage powder by introducing water, obtainable by a process as previously described.

The invention also relates to a capsule for preparing a beverage from a beverage powder by introducing water, preferably a capsule as previously described. The capsule has a coating comprising at least one layer. The at least one layer has a degree of swelling of between 20% and 900%, preferably 60 to 850% and most preferably between 100% and 800%; and/or the capsule expands upon contact with water by 0.3 to 6.0%, preferably 0.5 to 5.5% and most preferably 1.0 to 4.0%; and/or the capsule exhibits, in particular after being rinsed with water, in a breaking strength test a maximum percentage expansion in a direction transverse to a pressing direction of at least 15%, in particular at least 20%, preferably at least 25%, particularly preferably at least 30%.

The coating of the capsule can have between two and fifty layers, preferably between two and twenty layers, very preferably between two and ten layers and most preferably between two and five layers. The thickness of the coating can be optimally adjusted via the number of layers, and stability and elasticity or flexibility can be adapted to the intended use.

Preferably, the individual layers of the coating have thicknesses between 30 and 600 μm, preferably between 50 and 300 μm, and most preferably between 50 and 200 μm. The coating thickness refers to the coating thickness in the dry state.

The capsule, in particular after being rinsed with water, can absorb a maximum force in the breaking strength test, as described above, of at least 25 N, in particular at least 50 N, preferably at least 100 N.

A maximum force of 25 N or more can ensure that the capsule can be tightly enclosed and deformed in a brewing chamber without being damaged. Even if the capsule is oversized relative to the brewing chamber, for example in one direction, the capsule can be tightly enclosed between two brewing chamber halves without damage to the shell so that a beverage can be prepared. If the core material is in the form of a compact, this can thus be deformed without damaging the shell and the core material can be broken up. Optimum extraction is ensured.

Advantageously, the capsule can absorb a maximum force in a dry state in a breaking strength test of at least 10 N, in particular at least 15 N, preferably at least 20 N.

Dry” or “in dry condition” is understood to mean that the capsule has not yet come into contact with water or other liquids, unless otherwise defined. This is the condition in which the capsule is delivered and inserted by the user into a beverage preparation machine.

A maximum force of at least 10 N for capsules in the dry state ensures that the capsule can be gripped by a user without special precautions and fed to a beverage preparation machine without the capsule breaking. The capsule can be packed and transported in a usual way, i.e. without special precautions.

The capsule can have a burst pressure of less than 5 bar when wet. This is advantageous because it allows the capsule to dissolve more easily during composting. The capsule will rupture even at relatively low stress, so that composting is favored.

The burst pressure is the internal pressure required to burst the capsule shell. To determine the burst pressure, the capsule is immersed in water at an initial temperature of 75° C. for 180 minutes. The water drops to room temperature during the immersion period. It must be ensured that the capsule is completely covered with water. If necessary, it must be held under water.

If the core material of the capsule is a compact, it must be loosened up. For this purpose, the capsule is subjected to a compression treatment after immersion in water. The capsule is compressed in all three dimensions by 5 mm each at a speed of 50 mm/min. The capsule is rotated by 45° and again compressed by 5 mm in all three dimensions. The capsule is then immersed in water at room temperature for a further 120 min. The capsule must not be damaged during the compression treatment. If the compact is not loosened, there is a risk that the burst pressure cannot be determined correctly, as the pressure in the compact cannot be passed on to the shell.

To determine the burst pressure, the capsule is inserted between two horizontal parallel plates, the upper plate being equipped with an injection needle. The plates do not exert any pressure on the capsule, only the injection needle penetrates the capsule shell. The tip of the needle or the injection port of the needle protrudes at least 0.5 mm further than the thickness of the wet capsule shell from the upper plate. Water at room temperature is introduced into the capsule through the injection needle, and the water pressure is continuously increased and monitored. The water pressure is increased until the capsule shell ruptures or bursts. The pressure required for rupture or bursting is the burst pressure.

The maximum capsule volume increase when filling the capsule with water, as described, at a pressure of maximum 18 bar can be at least 15%, in particular at least 20%, preferably at least 25%, particularly preferably at least 30%, based on the initial volume, without damaging the shell.

The coating may have a surface-adjusted Oxygen Transmission Rate (OTR) in units of cm³ per m² per day per 0.21 bar of less than 50, preferably less than 20, more preferably less than 10, especially preferably less than 5. The OTR indicates the amount of oxygen diffused through the shell per unit area and time. With such OTR values, it can be ensured that the freshness of the capsules is guaranteed for at least three months after opening a package. The consumer can thus store the capsules for a certain period of time with the packaging open without any loss of quality.

Preferably, the complete capsule is home compostable according to the certification schemes NF T 51-800 and/or AS 5810. In this context, “home compostable” means that the material is at least home compostable according to the certification schemes NF T 51-800:2015-11-14 (Plastics—Specifications for plastics suitable for home composting) and/or AS 5810:2010 (Biodegradable plastics—Biodegradable plastics suitable for home composting). This means a decomposition (biodegradation) of at least 90% of the material with release of CO₂ within 12 months at a temperature of 25±5° C. as well as a fragmentation (disintegration) of at least 90% of the material within 6 months at a temperature of 25±5° C. The capsule can thus be handed over for composting after use. No separate disposal is necessary.

The capsule may have a round, in particular spherical, shape. However, it is also conceivable that the shape of the capsule essentially corresponds to other geometric bodies, such as a cube, cuboid, prism, pyramid, cylinder, truncated cone, cone, torus, ellipsoid, etc. It should be noted that any corners and edges are preferably not sharp but rounded.

A third aspect of the invention relates to the use of a capsule as previously described to prepare a beverage. For this purpose, the capsule may be inserted into a beverage preparation machine. The beverage preparation machine includes a brewing chamber having a mold and a brewing volume for receiving the capsule. The brewing chamber has penetration means for piercing and introducing water into the capsule, and perforation means for forming an outlet from the capsule. The capsule has a shape and a dry volume prior to the introduction of water into the capsule and a wet volume during the introduction of water. During the introduction of water, the wet volume of the capsule increases. The shell of the capsule is configured to be deformable such that the shape of the capsule is adaptable to the shape of the brewing chamber substantially without damage to the shell. The maximum wet volume of the capsule during beverage preparation is substantially equal to the brewing volume of the brewing chamber.

The maximum wet volume is understood to be the maximum volume of the capsule enclosed in the brewing chamber which the capsule takes up during the introduction of water into the capsule. Here, to determine the maximum wet volume, 200 ml of water is introduced into the capsule under a pressure of 6 bar at a flow rate of 200 ml/min.

The deformable design of the shell and the matching of the volume of the capsule to the chamber volume of the brewing chamber during the introduction of water into the capsule can ensure that the capsule and the brewing chamber are optimally matched. For example, it is not necessary for the volume of the capsule to match that of the brewing chamber even before the capsule is used. It is even conceivable that a capsule with a smaller diameter can be used, which is larger than a smallest diameter of the brewing chamber. Likewise, capsules with different sizes can be used with the same brewing chamber. For example, the capsule can thus be manufactured without adhering to tight tolerances and without sacrificing quality. The manufacturing costs can be reduced.

The present invention is described in more detail below with reference to examples. It also shows:

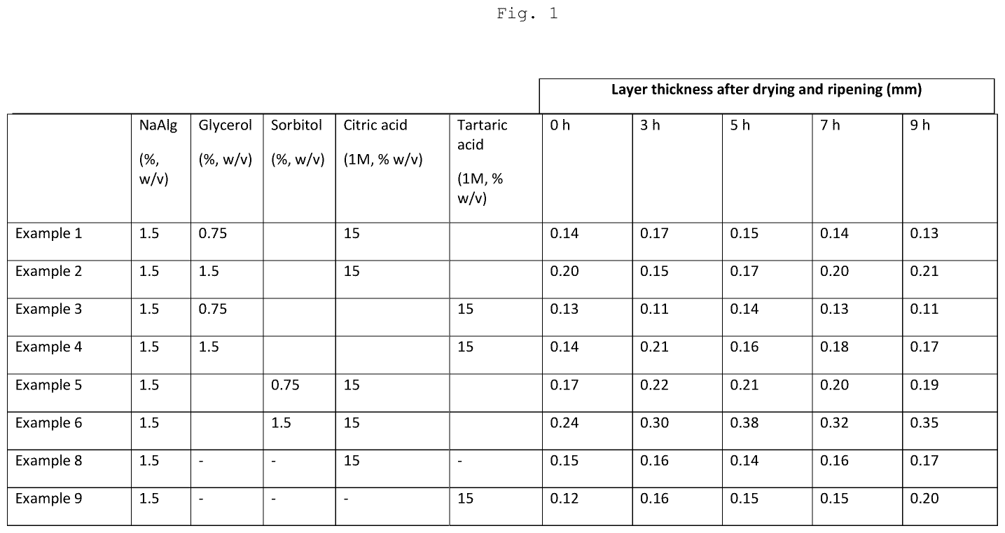

FIG. 1: An overview of the respective determined film thickness after drying and as a function of the ripening time for examples with citric acid and tartaric acid as crosslinking agents.

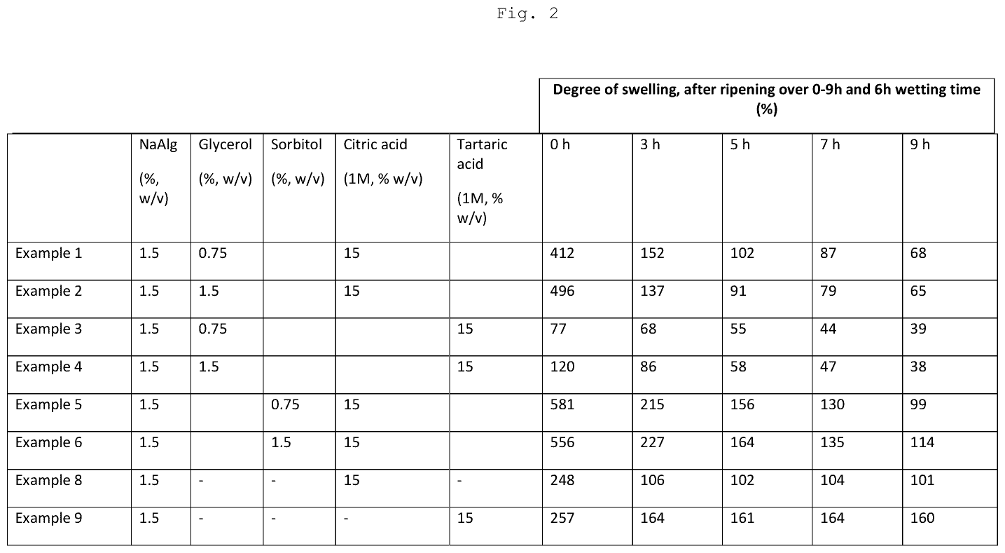

FIG. 2: An overview of the respective degree of swelling as a function of the ripening time for examples with citric acid or tartaric acid as crosslinking agent.

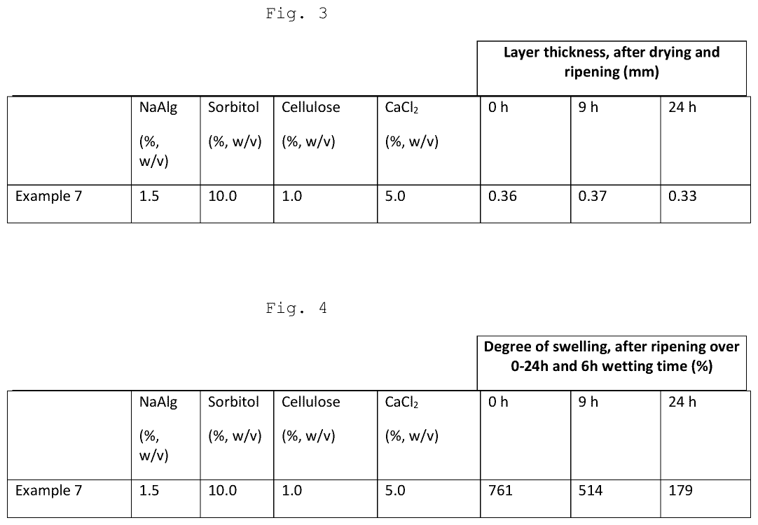

FIG. 3: The determined film thickness as a function of the ripening time for CaCl₂ as crosslinking agent.

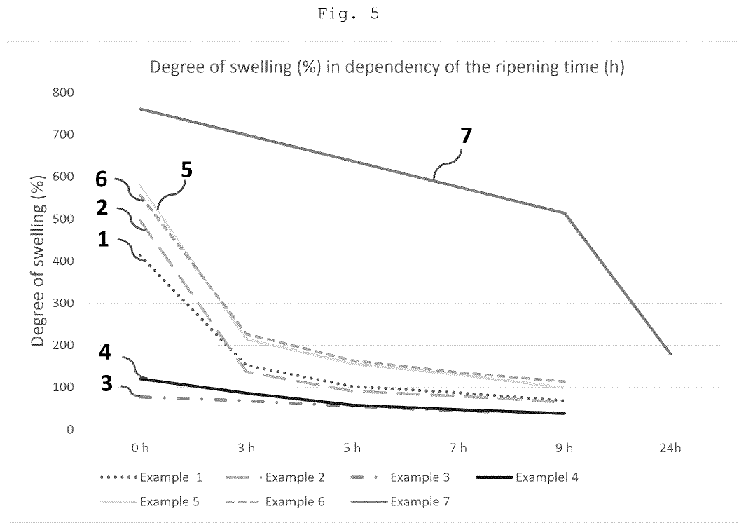

FIG. 4: the degree of swelling as a function of ripening time for CaCl₂ as crosslinking agent.

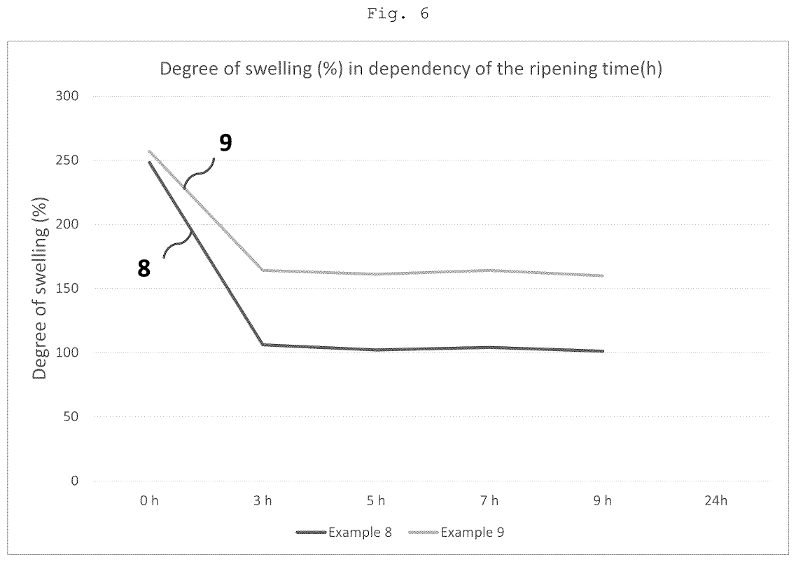

FIG. 5: Graphical representation of the degree of swelling as a function of the ripening time for examples 1 to 7.

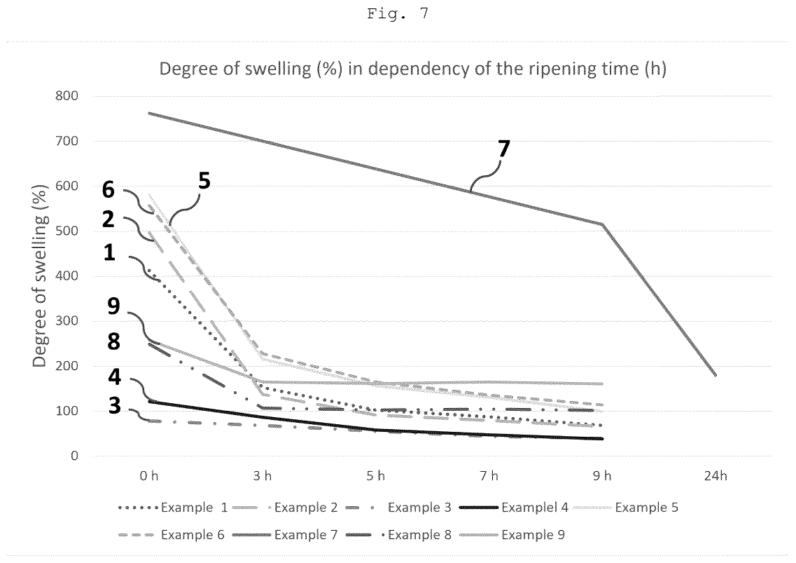

FIG. 6: Graph of the degree of swelling as a function of the ripening time for examples 8 and 9.

FIG. 7: Graph of the degree of swelling as a function of the ripening time for examples 1 to 9.

### EXAMPLES

### Example 1

1.5% (w/v) of a sodium alginate solution (4.05 g sodium alginate in 270 mL deionized water) was mixed with 2.025 g glycerol to give a concentration of 0.75% (w/v) glycerol. Subsequently, 40.5 g of a 1 M citric acid solution was added stepwise and stirred for 20 min. The mixture was poured into a Plexiglas container and dried at 35° C. for 120 to 140 h until constant weight. The samples were then subjected to different ripening times at 70° C. (0, 3, 5, 7, or 9 h), punched out in a circular shape (d=2.5 cm), and weighed.

Subsequently, samples were soaked in 30 mL deionized water for 6 h, patted dry, reweighed, and the degree of swelling was calculated.

### Example 2

1.5% (w/v) of a sodium alginate solution (4.05 g sodium alginate in 270 mL deionized water) was mixed with 4.05 g glycerol to give a concentration of 1.5% (w/v) glycerol. Subsequently, 40.5 g of a 1 M citric acid solution was added stepwise and stirred for 20 min. The mixture was poured into a Plexiglas container and dried at 35° C. for 120 to 140 h until constant weight. The samples were then subjected to different ripening times at 70° C. (0, 3, 5, 7, or 9 h), punched out in a circular shape (d=2.5 cm), and weighed.

Subsequently, samples were soaked in 30 mL deionized water for 6 h, patted dry, reweighed, and the degree of swelling was calculated.

### Example 3

1.5% (w/v) of a sodium alginate solution (4.05 g sodium alginate in 270 mL deionized water) was mixed with 2.025 g glycerol to give a concentration of 0.75% (w/v) glycerol. Subsequently, 40.5 g of a 1 M tartaric acid solution was added stepwise and stirred for 20 min. The mixture was poured into a Plexiglas container and dried at 35° C. for 120 to 140 h until constant weight. Samples were then subjected to different ripening times at 70° C. (0, 3, 5, 7, or 9 h), punched out circularly (d=2.5 cm), and weighed.

Subsequently, samples were soaked in 30 mL deionized water for 6 h, patted dry, reweighed, and the degree of swelling was calculated.

### Example 4

Example 4 was performed analogously to Example 3, using 4.05 g of glycerol, resulting in a 1.5% (w/v) glycerol solution.

### Example 5

Example 5 was carried out analogously to Example 1. In this example, however, 2.025 g sorbitol were used, resulting in a 0.75% (w/v) sorbitol solution.

### Example 6

Example 6 was performed analogously to Example 5. In this example, however, a 1.5% (w/v) sorbitol solution was used.

All examples are again compiled in FIG. 2, indicating the degree of swelling determined.

To determine the layer thicknesses, the samples obtained in the examples were punched out in circles with a circle diameter of 2.5 cm after the drying or ripening time and before immersing in water, and the layer thicknesses were measured with a RUPAC/IP54 digital caliper, resolution 0.01 mm. For each sample, 10 measurements were taken at different points on the sample and the mean value was calculated from these. The layer thicknesses determined in this way are shown in FIG. 1.

### Example 7

A mixture of sodium alginate (1.5% w/v), cellulose (1% w/v) and sorbitol (10% w/v) was cast into films and then crosslinked with an aqueous calcium chloride solution (5% w/v). The film was then dried at 35° C. for 120 to 140 h until constant weight. The samples were then subjected to different ripening times at 70° C. (0, 9 or 24 h), punched out circularly (d=2.5 cm) and weighed.

Subsequently, samples were soaked in 30 mL deionized water for 6 h, patted dry, reweighed, and the degree of swelling was calculated.

The results for the degree of swelling are shown in FIG. 4.

To determine the layer thicknesses, the sample obtained in Example 7 was punched out in circles with a circle diameter of 2.5 cm after the drying or ripening time and before soaking in water, and the layer thicknesses were measured with a RUPAC/IP54 digital caliper, resolution 0.01 mm. For each sample, 10 measurements were taken at different points on the sample and the mean value was calculated from these. FIG. 3 shows the layer thicknesses determined in this way.

### Comparison Examples

### Example 8

Example 8 was performed as Example 1, except that no polyol was used.

### Example 9

Example 9 was carried out in the same way as Example 3, except that no polyol was used.

### Capsule Production

### Example 10—Production of a Capsule

According to the above, a capsule was produced from a compact comprising a coating of three layers. The compact of 5.7 g coffee powder was first immersed in an aqueous 1% alginate solution containing 10% sorbitol and then in a 5% calcium chloride solution for 5 seconds.

The resulting compact, after drying the first layer of alginate, sorbitol and calcium ions, was immersed in a second aqueous solution of 1.5% alginate, 10% sorbitol and 1% cellulose and then re-crosslinked and dried in a 5% calcium bath for 5 sec.

The resulting compact with two layers was immersed in an aqueous 1.7% alginate solution containing 1% cellulose, then again cross-linked in a calcium bath and dried.

The capsule thus obtained consisted of three layers, in which
the first layer cross-linked alginate and sorbitol,
the second layer crosslinked alginate, sorbitol and cellulose, and
the third layer cross-linked alginate and cellulose, exhibited.

FIG. 5 shows the setting of degree of swelling as a function of the ripening time. The numbering corresponds to the examples. Graph 1 indicates the progression for example 1, graph 2 for example 2, etc. It was shown that the degree of swelling of the applied layer is adjustable in the presence of a polyol and decreases with increasing ripening time.

As can be seen from FIGS. 2 and 6, the degree of swelling for Examples 8 and 9 cannot be adjusted without polyol. From 3 hours of ripening on, the degree of swelling remains almost constant and can no longer be varied. Surprisingly, it has been shown that the presence of a polyol has a significant influence on the setting of the degree of swelling.

1-21. (canceled)

22. A method of manufacturing a capsule having a coating, for preparing a beverage from a beverage powder by introducing water, comprising the steps of:
(i) Providing a compact of a beverage powder or a mixture of beverage powders, the compact having a surface that is coated or uncoated;
(ii) contacting at least a portion of the surface of the compact with at least one polysaccharide, at least one crosslinking agent, and at least one polyol to form a layer;
(iii) Drying of the layer;
wherein
the layer formed in ii) and iii) is adjusted with a degree of swelling of between 20% and 900%; and/or
the capsule is expanded on contact with water by 0.3% to 6%.

23. The method according to claim 22, wherein the polyol after step iii) is crosslinked with the at least one polysaccharide and/or is intercalated into the coating.

24. The method according to claim 22, wherein the adjustment of the degree of swelling is carried out by heat treatment at a temperature below 100° C.

25. The method according to claim 22, wherein steps (ii) and (iii) are repeated a plurality of times.

26. The method according to claim 22, wherein the compact according to step (iii) is additionally contacted with at least one further polysaccharide and at least one cellulose or cellulose derivative.

27. The method according to claim 22, wherein the at least one polysaccharide of the coating is selected from the group consisting of alginates, starch, starch derivatives, carrageenans, cellulose, cellulose derivatives, chitin, chitosan, pectins, guar, xanthan gum, locust bean gum, gum arabic, pullulan, and agar; and combinations thereof.

28. The method according to claim 22, wherein the at least one polysaccharide is alginate.

29. The method according to claim 22, wherein the at least one crosslinking agent is selected from compounds having one or more carbonyl and/or carboxyl functions.

30. The method according to claim 29, wherein the at least one crosslinking agent is selected from the group consisting of citric acid, fumaric acid, maleic acid, tartaric acid, malic acid, and adipic acid; and combinations thereof.

31. The method according to claim 22, wherein the at least one crosslinking agent is a salt of a divalent or higher-valent cation.

32. The method according to claim 22, wherein the at least one polyol is selected from the group consisting of aliphatic polyols; cyclic polyols; sugar substitutes; and aromatic polyols; and combinations thereof.

33. The method according to claim 22, wherein the at least one polysaccharide comprises an alginate, wherein the at least one polyol comprises glycerol, and wherein the at least one crosslinking agent comprises citric acid.

34. The method according to claim 22, wherein the at least one polysaccharide comprises an alginate, wherein the at least one polyol comprises glycerol, and wherein the at least one crosslinking agent comprises tartaric acid.

35. The method according to claim 22, wherein the at least one polysaccharide comprises an alginate, wherein the at least one polyol comprises sorbitol, and wherein the at least one crosslinking agent comprises citric acid.

36. The method according to claim 22, wherein the at least one polysaccharide comprises an alginate, wherein the at least one polyol comprises sorbitol, and wherein the at least one crosslinking agent comprises calcium chloride.

37. A capsule for preparing a beverage from a beverage powder or a beverage powder mixture by introducing water, obtainable by a method according to claim 22.

38. A capsule for preparing a beverage by introducing water, wherein the capsule comprises a coating of at least one layer, wherein
the at least one layer has a degree of swelling of between 20% and 900%; and/or
the capsule expands on contact with water by 0.3% to 6.0%.

39. The capsule according to claim 37, wherein the coating comprises between two and fifty layers.

40. The capsule according to claim 38, wherein the coating comprises between two and fifty layers.

41. The capsule according to claim 39, wherein the individual layers of the coating have thicknesses between 30 and 600 μm.

42. The capsule according to claim 40, wherein the individual layers of the coating have thicknesses between 30 and 600 μm.

43. The capsule according to claim 37, wherein the capsule absorbs a maximum force in the breaking strength test of at least 25 N.

44. The capsule according to claim 38, wherein the capsule absorbs a maximum force in the breaking strength test of at least 25 N.
